(19) United States
(12) Patent Application Publication
(10) Pub. No.: US 2010/0185648 A1
(43) Pub. Date: Jul. 22, 2010

(54) ENABLING ACCESS TO INFORMATION ON A WEB PAGE

(75) Inventors: Himanshu Chauhan, New Delhi (IN); Om D. Deshmukh, New Delhi (IN); Vijay Kumar Garg, Haryana (IN); Sachindra Joshi, New Delhi (IN); Ashish Verma, New Delhi (IN)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/353,669

(22) Filed: Jan. 14, 2009

(51) Int. Cl. G06F 7/06; G06F 17/30

(52) U.S. Cl. 707/769; 707/E17.015; 707/E17.108

(57) ABSTRACT

Techniques for enabling voice access to information residing on the World Wide Web are provided. The techniques include receiving a query from a user, wherein the query comprises a voice-based request to access information residing on the World Wide Web, identifying one or more websites corresponding to the query, fetching the information from a website, wherein fetching the information comprises executing a hypertext transfer protocol (HTTP) request, organizing the information into a voice-based response and delivering the response to the user.

### FIELD OF THE INVENTION

Embodiments of the invention generally relate to information technology, and, more particularly, to accessing internet resources.

### BACKGROUND OF THE INVENTION

The internet or web (that is, World Wide Web) is an extremely rich source of information. However, a significant number of people cannot take advantage of this resource because they, for example, do not have computer skills and/or language skills. Also, others may have physical limitations or simply may not have access to the web (for example, only having access to a telephone). As a result, it would be beneficial to enable those who are unable to access the web to nonetheless take advantage of its resources.

### SUMMARY OF THE INVENTION

Principles and embodiments of the invention provide techniques for enabling access to information on the World Wide Web. An exemplary method (which may be computer-implemented) for enabling voice access to information residing on the World Wide Web, according to one aspect of the invention, can include steps of receiving a query from a user, wherein the query comprises a voice-based request to access information residing on the World Wide Web, identifying one or more websites corresponding to the query, fetching the information from a website, wherein fetching the information comprises executing a hypertext transfer protocol (HTTP) request, organizing the information into a voice-based response and delivering the response to the user.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a system to enable a person to access the information available on the web through an automated system, according to an embodiment of the present invention;

FIG. 2 is a diagram illustrating techniques for request creation and response generation, according to an embodiment of the present invention;

FIG. 3 is a diagram illustrating technical steps involved at run-time for reaching the information and extracting relevant information in an iterative manner, according to an embodiment of the present invention;

FIG. 4 is a flow diagram illustrating techniques for enabling voice access to information residing on the World Wide Web, according to an embodiment of the present invention; and

FIG. 5 is a system diagram of an exemplary computer system on which at least one embodiment of the present invention can be implemented.

### DETAILED DESCRIPTION OF EMBODIMENTS

Principles of the invention include extracting relevant information from the internet or World Wide Web given a user's query over phone. One or more embodiments of the invention enable a person, who is unable to access web due to, for example, physical reasons, educational reasons, economical reasons, traveling, etc., to access the information available on the web through an automated system. As described herein, a user does not have to be exposed to the web browsing concept to get the information he or she is looking for.

The techniques described herein do not require a user to know on which website(s) the information resides which he or she is looking for. The techniques also do not require complete hypertext markup language (HTML) to voice extensible markup language (VXML) conversion of any particular website.

One or more embodiments of the invention include searching and extracting relevant information for a voice-based query obtained through a telecommunication device. By way of example, the techniques described herein can include obtaining a voice query and searching the web and/or information portal to obtain relevant information corresponding to the voice query and rendering the information back to the user in a voice or other-desired format.

Additionally, one or more embodiments of the invention include conducting an automatic search over the internet using any mobile or landline phone and without any tie-ups with content providers. Further, one can convert the relevant search output to voice format (for example, in a voice format that is in the user's local language). One can also facilitate voice-enabling web interactions (for example, form-filling) as well as extract precise answers to a user's query by performing information extraction on the query output from the internet pages.

The techniques described herein also include a multi-step interaction with the user where the dialogue flow can change based on the output from the internet. Additionally, one or more embodiments of the invention include a user-driven generation of web browsing steps, as well as storing these steps for further use by other users.

By way of illustration, consider the following scenario. A person wants to go from station A to B. He wants to know what trains are available, their schedule, etc. He has only a phone and is not familiar with the web. As such, one or more embodiments can access a relevant website, obtain the required inputs from the user (for example, source, destination, class, dates, etc.), fetch the information from the web and give it back to the user.

Such a process can be started, for example, by receiving a user's call and, based on her voice, prompt for train information redirecting her to dialogue component which handles input collection for the train enquiry. Once these afore-mentioned inputs are collected, the system connects to the relevant website and sends a query (similar to a form submission by a human) to the webpage with inputs provided from the user. After receiving the response web-page for the sent query, the system attempts to extract concise and relevant information based on the conversation context (for example, if the user wanted to know about fare, the system looks for patterns of fare and/or currency and extracts this text from the page). This text is delivered to a dialogue component module which uses a text-to-speech engine to relay the information in voice format to the user.

Also, note that one or more embodiments of the invention do not require any integration with a railway's backend database.

In another illustrative example, a person wants to know the interest rates offered by various banks for a home loan. As such, the system described herein can go to a popular and/or relevant website, obtain the required inputs from the user (for example, term, floating, fixed, etc.), fetch the information from the web and give it back to the user (for example, the lowest interest rate offered).

In yet another example, a person is planning a trip to Chennai and wants to know the current weather there. One or more embodiments can access a relevant website, fill up the form, speak the weather over phone in local language or reply back to the user in another manner. Filling up the form can include, for example, reading the label data and setting value of a corresponding HTML input element (for example, textbox, checkbox, etc.) to the equivalent value provided by user. This can be performed for all of the inputs collected from the user.

As noted above, a wide variety of services can be provided as information on the web. In one or more embodiments of the invention, the web content is not permanently maintained. By way of example, the content can be stored (for example, for news, sports, etc.) for limited services provided by the telecom operators.

Also, in another illustrative example, a user can have an exchange with a Genie (that is, the operator of the system) such as the following.
User: I want to know about India.
Genie: Do you want to know about Indian food, Indian tourism places or Indian culture?
User: I want to know about Indian tourism.
Genie: Which part of India: South, North, East or West?
User: North.
Genie: There are hill stations to visit in North India: Shimla, Kashmir, Leh, etc.
User: What is the current temperature in Shimla?

In such a scenario, at any given step, the Genie searches the World Wide Web using the keywords related to user's query, categorizes the results, communicates to the user and obtains more inputs from the user to go to the next level of detail.

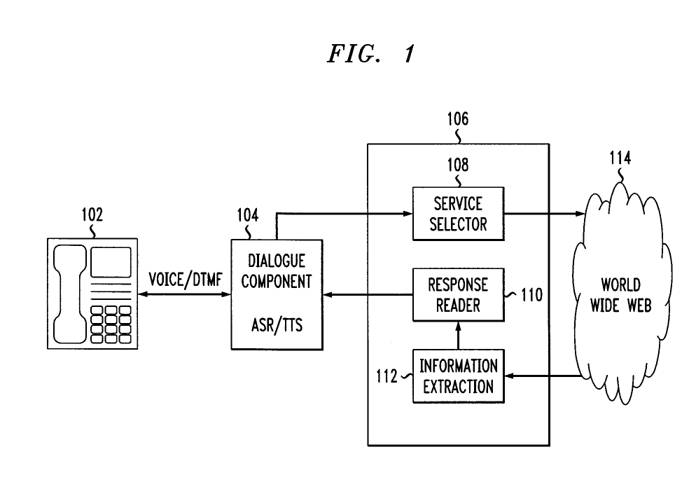

FIG. 1 is a diagram illustrating a system to enable a person to access the information available on the web through an automated system, according to an embodiment of the present invention. By way of illustration, FIG. 1 depicts a telephone 102, a dialogue component 104 (that can interact with the telephone 102 via voice or dual-tone multi-frequency), a system component 106 that includes a service selector 108, a response reader 110 and an information extraction component 112, as well as the World Wide Web 114. The dialogue component 104 can, for example, utilize automatic speech recognition (ASR) and/or text-to-speech (TTS) capabilities. It can also include language translation capabilities to interact with the user in his or her local language and then translate the request/response for information extraction from the World Wide Web.

The dialogue component 104 utilizes automatic speech recognition (ASR) to identify user utterances and map them to corresponding input value and/or text-to-speech (TTS) capabilities to convert extracted information text to audio, which can be relayed to the user. The service selection component 108 is responsible for identifying the web-site/page/service that the system should query for the desired information. The service selection component 108 maintains a registry of such web-sites/pages/services, some pre-configured and some added to the system based on usage-learning.

Information extraction component 112 receives response HTML pages from websites based on the query sent, and extracts the relevant information from the page. The information extraction component 112 uses a combination of various extraction techniques which can include, for example, schema based extraction, domain ontologies for inference model, HTML syntax based information extraction, etc. This extracted information can be forwarded to a response reader 110. A response reader 110 formulates natural language-like responses by adding context based phrases to information text received from the information extraction component 112. The response text can be forwarded to a text-to-speech engine of the dialogue component 104, which can convert the text to audio and relay it to the user.

As described herein, one or more embodiments of the invention include a using a user input query, which can include, for example, a voice extensible mark-up language (VXML) application with fixed grammars and/or speech recognition over a telephone with basic natural language understanding (NLU). Also, as illustrated in FIG. 1, the techniques described herein include information extraction, which can include selection of a specific website relevant to user's query, collecting the required input (if any) from the user, forming the hypertext mark-up language (HTML) request, fetching the webpage containing the information, and extracting the information from the results page.

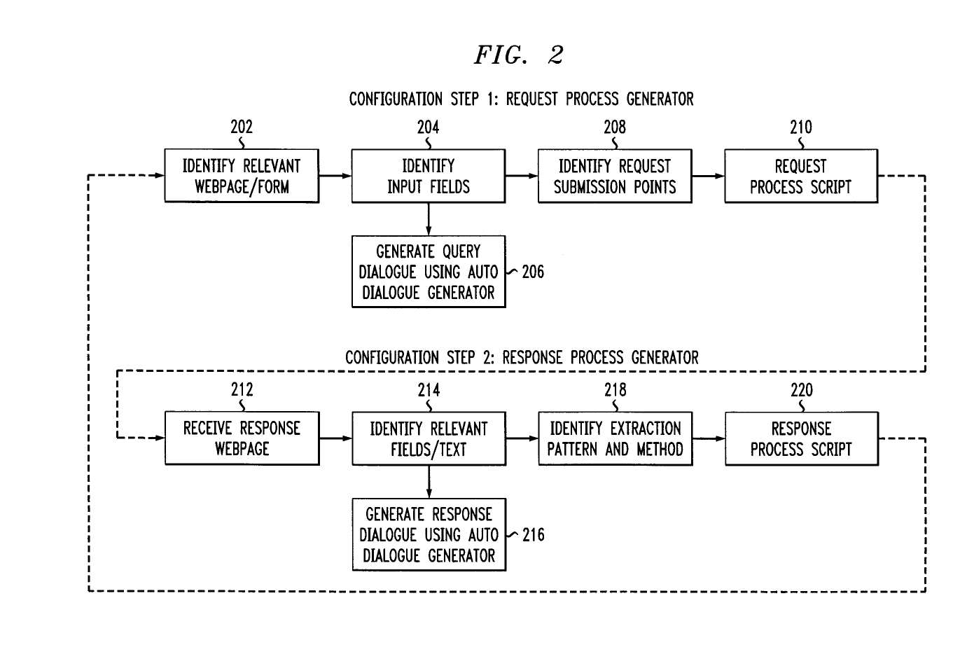

FIG. 2 is a diagram illustrating techniques for request creation and response generation, according to an embodiment of the present invention. Step 202 includes identifying a relevant web page and/or form. Step 204 includes identifying input fields. Also, step 206 includes generating a query dialogue using an auto dialogue generator. Step 208 includes identifying request submission points. Further, step 210 includes requesting a process script.

Step 212 includes receiving a response web page. Step 214 includes identifying relevant fields and/or text. Also, step 216 includes generating a response dialogue using an auto dialogue generator. Step 218 includes identifying an extraction pattern and method. Further, step 220 includes responding with a process script.

FIG. 2 depicts a request process generator (also identified in FIG. 2 as configuration step 1). A request process generator includes generating a pre-configured process to reach the information content. As described herein, the steps in request process generation include identifying a website and/or web-form that is relevant for the information retrieval. The inputs required to obtain the information through a phone are assumed to be same as inputs required by the web-form and, hence, these form inputs are identified and used for automatic generation of query dialogue. After identifying the inputs, request submission details (for example, query string/submit actions) are also identified. These submission are used to send a request (having user input) to receive information in the corresponding response page.

FIG. 2 also depicts a response process generator (also identified in FIG. 2 as configuration step 2). In a similar manner to the request process generator, a response process generator is also created for an identified web interaction. This process generator captures the steps and details required to extract information from a web response page. After receiving the response for a generated request process, relevant text content and other fields in the response page are identified. After identification, details of these fields are sent to automatic dialogue generation to generate the appropriate response prompts. Identification of fields of interest leads to identification of a pattern in which the fields appear in the response. Based on the pattern identified, a suitable information extraction method is attached to the response page. The collection of fields of interest, their pattern in the response page and information the extraction method attached, along with generation of a response dialogue completes the configuration step for response process generation.

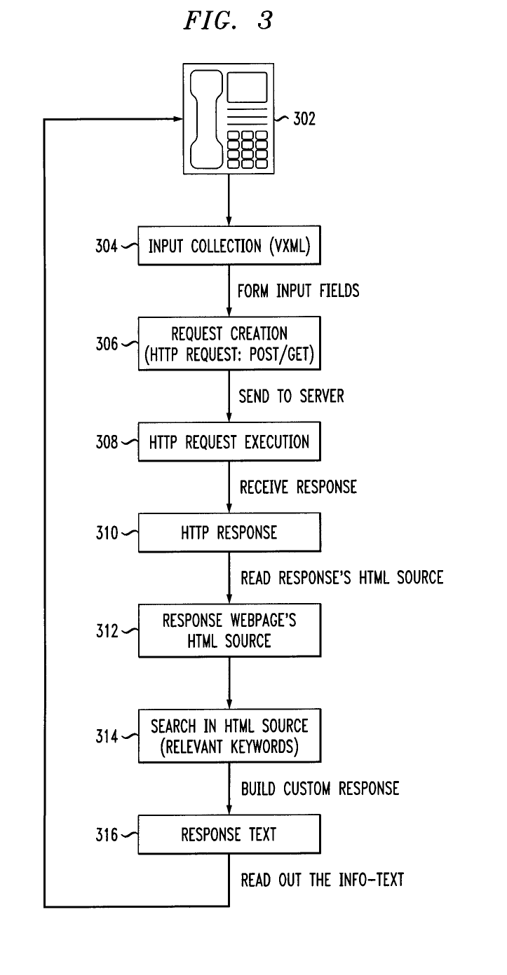

FIG. 3 is a diagram illustrating technical steps involved at run-time for reaching the information and extracting relevant information in an iterative manner, according to an embodiment of the present invention. By way of illustration, FIG. 3 depicts a telephone 302. FIG. 3 also depicts steps as follows. Step 304 includes collecting input (for example, using voice extensible markup language (VXML)). Step 306 includes creating a HTTP request to the identified web resource using a preconfigured request process generator. Step 308 includes executing the generated HTTP request, as well as using the generated request process.

Also, step 310 includes receiving the HTTP response for the executed request. As configured in the response process generator, steps 312 and 314 include extracting the information of interest based on the identified fields and pattern. Step 316 includes generating response text. This generated response can be read out over the telephone 302.

One or more embodiments of the invention can also include language translation. By way of example, one can transform the user's query into English, search the web and obtain the results, and communicate the result in user's language.

Additionally, the techniques described herein include de-linking information content and web browsing on a computer. For example, a user may not know that the information is available on a particular website. As such, one or more embodiments of the invention can include performing web browsing instead of or for the user. The system can provide additional services such as, for example, language translation, and can make the existing web content available over the phone. In such a scenario, no change would be required in the existing websites or in the way websites are created.

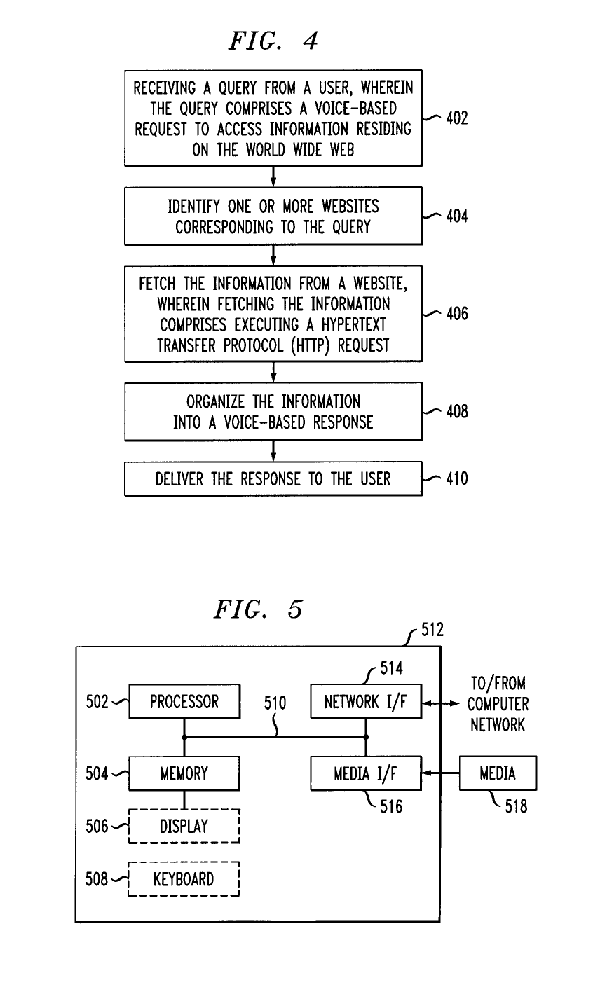

FIG. 4 is a flow diagram illustrating techniques for enabling voice access to information residing on the World Wide Web, according to an embodiment of the present invention. Step 402 includes receiving a query from a user, wherein the query comprises a voice-based request to access information residing on the World Wide Web.

Step 404 includes identifying one or more websites corresponding to the query. Identifying websites corresponding to the query can include identifying one or more hypertext mark-up language keywords. Step 406 includes fetching the information from a website, wherein fetching the information comprises executing a hypertext transfer protocol (HTTP) request.

Step 408 includes organizing the information into a voice-based response. Step 410 includes delivering the response to the user. Delivering the response to the user can include, for example, generating a response text and/or using a voice application to render the information back to the user over a telephone.

One or more embodiments of the invention also include generating a hypertext transfer protocol (HTTP) request, wherein generating the HTTP request comprises using data gathered from the user. Gathering data from the user can include using a request generator module. A request generator module can be generated once for a given type of user query and web site by determining the data necessary for the given query and generating a corresponding dialogue management module. Additionally, a request generator module can be generated at run-time for a given user query and web site by determining the data necessary for the given query and generating a corresponding dialogue management module.

The techniques depicted in FIG. 4 can also include facilitating voice-enabling web interactions (for example, form-filling), as well as storing user-driven web-browsing steps (for example, for further use by other users). One or more embodiments of the invention also include language translation. For example, the query can be translated from the language spoken by the user into English, and the rendered information (that is, response) can be translated into the preferred language of the user.

Also, the techniques depicted FIG. 4 also include processing the information using a response processor module. A response processor module can be generated once for a given type of user query and web site by determining one or more desired outputs from the fetched information from the website. Also, a response processor module can be generated at run-time for a given type of user query and web site by determining one or more desired outputs from the fetched information from the website.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 5, such an implementation might employ, for example, a processor 502, a memory 504, and an input and/or output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 502, memory 504, and input and/or output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 518) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 504), magnetic tape, a removable computer diskette (for example, media 518), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, enabling a person who is unable to access the web to access the information available on the web through an automated system.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for enabling voice access to information residing on the World Wide Web, comprising the steps of:
receiving a query from a user, wherein the query comprises a voice-based request to access information residing on the World Wide Web;
identifying one or more websites corresponding to the query;
fetching the information from a website, wherein fetching the information comprises executing a hypertext transfer protocol (HTTP) request;
organizing the information into a voice-based response; and
delivering the response to the user.

2. The method of claim 1, further comprising generating a hypertext transfer protocol (HTTP) request, wherein generating the HTTP request comprises using data gathered from the user.

3. The method of claim 2, wherein gathering data from the user comprises using a request generator module.

4. The method of claim 3, wherein the request generator module is generated once for a given type of user query and web site by determining the data necessary for the given query and generating a corresponding dialogue management module.

5. The method of claim 3, wherein the request generator module is generated at run-time for a given user query and web site by determining the data necessary for the given query and generating a corresponding dialogue management module.

6. The method of claim 1, further comprising processing the information using a response processor module.

7. The method of claim 6, wherein the response processor module is generated once for a given type of user query and web site by determining one or more desired outputs from the fetched information from the website.

8. The method of claim 6, wherein the response processor module is generated at run-time for a given type of user query and web site by determining one or more desired outputs from the fetched information from the website.

9. The method of claim 1, wherein identifying one or more websites corresponding to the query comprises identifying one or more hypertext mark-up language keywords.

10. The method of claim 1, wherein delivering the response to the user comprises at least one of generating a response text and using a voice application to render the information back to the user over a telephone.

11. The method of claim 1, further comprising language translation.

12. The method of claim 11, wherein the rendered information is translated into a preferred language of the user.

13. A computer program product comprising a computer readable medium having computer readable program code for enabling voice access to information residing on the World Wide Web, said computer program product including:
computer readable program code for receiving a query from a user, wherein the query comprises a voice-based request to access information residing on the World Wide Web;
computer readable program code for identifying one or more websites corresponding to the query;
computer readable program code for fetching the information from a website, wherein fetching the information comprises executing a hypertext transfer protocol (HTTP) request;
computer readable program code for organizing the information into a voice-based response; and
computer readable program code for delivering the response to the user.

14. The computer program product of claim 13, further comprising computer readable program code for generating a hypertext transfer protocol (HTTP) request, wherein generating the HTTP request comprises using data gathered from the user.

15. The computer program product of claim 14, wherein the computer readable program code for gathering data from the user comprises computer readable program code for using a request generator module.

16. The computer program product of claim 13, further comprising computer readable program code for processing the information using a response processor module.

17. A system for enabling voice access to information residing on the World Wide Web, comprising:
a memory; and
at least one processor coupled to said memory and operative to:
receive a query from a user, wherein the query comprises a voice-based request to access information residing on the World Wide Web;
identify one or more websites corresponding to the query;
fetch the information from a website, wherein fetching the information comprises executing a hypertext transfer protocol (HTTP) request;
organize the information into a voice-based response; and
deliver the response to the user.

18. The system of claim 17, wherein the at least one processor coupled to said memory is further operative to generate a hypertext transfer protocol (HTTP) request, wherein generating the HTTP request comprises using data gathered from the user.

19. The system of claim 18, wherein in gathering data from the user the at least one processor coupled to said memory is further operative to use a request generator module.

20. The system of claim 17, wherein the at least one processor coupled to said memory is further operative to process the information using a response processor module.
